(19) United States
(12) Patent Application Publication
(10) Pub. No.: US 2004/0208465 A1
(43) Pub. Date: Oct. 21, 2004

(54) Planar waveguide structure with tightly curved waveguides

(76) Inventors: Yury Logvin, Ottawa (CA); Serge Grabtchak, Orleans (CA); Kirill Pimenov, Orleans (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/826,504

(22) Filed: Apr. 19, 2004

Related U.S. Application Data
(60) Provisional application No. 60/463,685, filed on Apr. 18, 2003.

(51) Int. Cl. G02B 6/10

(52) U.S. Cl. 385/129

(57) ABSTRACT

Ridge and buried waveguide structures feature trenches disposed proximate the waveguides in order to enhance confinement of an optical signal propagating within the waveguide are described. Additionally, an adiabatic transition region in which the distance between the trenches and the waveguide is featured.

This application claims the benefit of U.S. Provisional Application No. 60/463,685 filed Apr. 18, 2003.

### FIELD OF THE INVENTION

This invention relates to integrated waveguide devices used in optical communications that are produced from planar waveguide substrates and more particularly to propagating optical signals within curved waveguides disposed within a substrate.

### BACKGROUND OF THE INVENTION

Optical components are extensively used in data communication networks. Typically these components are designed to manipulate light having a single mode. Advances in optical technology have provided integrated optical devices that permit more complex optical components and combinations of optical components to be produced on a single optical chip. When the optical chip relies of on weakly guiding waveguides, it is often difficult to provide a curved waveguide whose radius of curvature is sufficiently low to permit a set of optical components on a same to chip to be located in close proximity to each other. Additionally, when the radius of curvature of a curved waveguide is high it often becomes difficult to position the waveguides such that the surface area of substrate is used effectively. Since the substrate is likely to be very costly, it is very beneficial to use a minimal amount of surface area.

While advances in total-internal-reflection (TIR) mirrors allow turning mirrors to be disposed on optical substrates in some applications it is often the case that these mirrors have insertion loss in the order of 1.0 dB. While this may be acceptable in some applications it is not acceptable for others and generally it is beneficial to minimize the insertion loss of optical components.

In U.S. Pat. No. 4,983,006, Hishimoto describes a polarization independent optical waveguide switch. The switch features two curved waveguides that approach each other forming an “X” shape in a top view of the device. This patent clearly demonstrates the usefulness of tightly curved waveguides in optical switching. The waveguides used in this prior art patent are widened near the junction where they are parallel. Hishimoto explains that a higher index contrast is desirable in a curved waveguide in order to enhance confinement of the optical signals as they propagate within the curved waveguide. While the thicker waveguides decrease radiation loss, and hence suggest improved confinement, the radius of curvature used by Hishimoto is still relatively large.

In U.S. Pat. No. 5,511,142, Horie et al. discuss a variety of different ridge waveguide structures intended for use with curved waveguides. The ridge waveguides described by Horie et al. have sections that are not flat. Thus, the ridge is designed to enhance confinement of light propagating within the curved waveguide on the inside of the curve of the waveguide while providing weaker guiding on the outside the waveguide thereby assisting the redirection of the light around the curve. While this prior art is superior to a conventional flat ridge waveguide the enhancement in terms of minimum radius of curvature is modest because the waveguide is still a weakly guiding waveguide. Additionally, it is felt that the processing of such a waveguide is more complex than the processing of a move conventional waveguide device.

In the paper “Air trenches for sharp silica waveguide bends”, IEEE Journal of Lightwave Technology, v.20, p. 1762 (2002), the authors M.Popovic et al. suggested an adiabatic taper from a low-index contrast to high-index contrast waveguide structure combined with a high-index contrast bend. Along with the obvious advantages of the structures especially for the implementation of the small radius bends, there are several drawbacks. Namely, there is a junction between the different waveguide structures where a mode mismatch loss is likely to be very significant. Additionally, the fabrication of the taper is questionable because it requires very accurate alignment of the masks used at different etching processes.

It would be beneficial to provide integrated waveguide substrates having curved waveguides, the curved waveguides having a relatively low radius of curvature and low optical losses. Further, it would be beneficial to provide this type of waveguide without resorting to unconventional and costly production techniques.

### SUMMARY OF THE INVENTION

In accordance with the invention there is provided a waveguide structure comprising:

a waveguide; comprising;

a curved waveguide portion that is curved having local radii of curvature, and

a first trench disposed on an inside of the curvature of the waveguide, said first trench having a low index of refraction material disposed therein, said first trench comprising;

a first portion of the first trench disposed sufficiently distant the waveguide to prevent a change in mode profile of an optical signal propagating therein,

a second trench portion of the first trench disposed sufficiently proximate said waveguide to substantially enhance confinement of an optical signal propagating within the curved waveguide portion, and

a third trench portion of the first trench disposed sufficiently distant the waveguide to prevent a change in mode profile of an optical signal propagating therein.

According to another aspect of the invention there is provided method of propagating an optical signal within a waveguide comprising:

providing an optical signal at an input port;

propagating said optical signal within a weakly confining portion of the waveguide;

propagating said optical signal within a transition region of the waveguide, said transition region of the waveguide supporting a near adiabatic optical mode transition; and,

propagating said optical signal within a strongly confining region of the waveguide.

Further, the invention teaches a storage medium for storing instructions for, when executed, resulting in a design for a waveguide structure, the waveguide structure comprising:

a waveguide comprising;

a curved waveguide portion that is curved having local radii of curvature, and

a first trench disposed on an inside of the curvature of the waveguide, said first trench having a low index of refraction material disposed therein, said first trench comprising;

a first portion of the first trench disposed sufficiently distant the waveguide to prevent a change in mode profile of an optical signal propagating therein,

a second trench portion of the first trench disposed sufficiently proximate said waveguide to substantially enhance confinement of an optical signal propagating within the curved waveguide portion, and,

a third trench portion of the first trench disposed sufficiently distant the waveguide to prevent a change in mode profile of an optical signal propagating therein.

### BRIEF DESCRIPTION OF THE DRAWINGS

The invention is now described with reference to the accompanying figures in which:

FIG. 1 is a top view of a prior art Mach-Zender interferometer disposed on waveguide structure;

FIG. 2 is a section view of a prior art waveguide indicating an intensity profile of optical signals propagating therein;

FIG. 3 is an isometric view of a curved waveguide according to the prior art in which the waveguide has been made thicker in the curved region;

FIG. 4 is a top view of a curved ridge waveguide according to the prior art in which a trench is disposed proximate a ridge waveguide in order to enhance the guiding of light within the waveguide

FIG. 5a is a top view of a curved waveguide structure according to the invention featuring trenches with transition regions proximate a curved waveguide;

FIG. 5b is a section view of the curved waveguide structure of FIG. 5a;

FIG. 6 is a top view of a curved waveguide structure according to another embodiment of the invention featuring a trench disposed on either side of a curved waveguide; and,

FIG. 7 is a section view of the curved waveguide structure of FIG. 6.

### DETAILED DESCRIPTION OF THE INVENTION

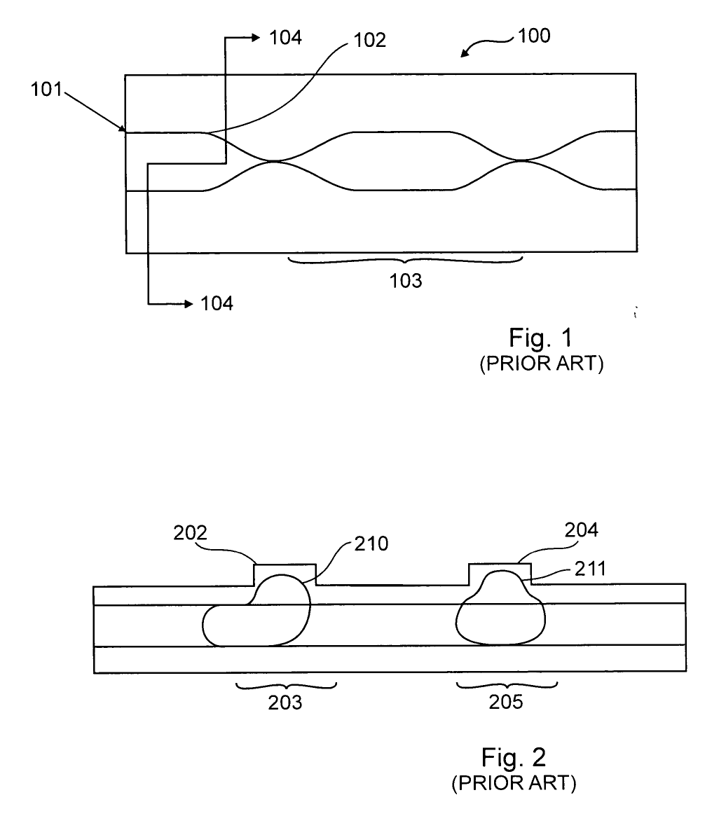

Referring to FIG. 1, a prior art waveguide substrate 100 is shown. The waveguide substrate includes an input port 101, a curved waveguide 102, and a Mach-Zender interferometer 103. A section line 104 is also shown. The radius of curvature has been chosen to ensure that the weakly guiding waveguide continues to determine the path of propagation of the optical signal. If the radius of curvature of the curved waveguide is reduced then the curved waveguide will be unable to confine the optical signal. As a result the light begins to dissipate within the waveguide and no longer propagates proximate the ridge of the ridge waveguide. The size of the device is constrained by the minimum radius of curvature of the curved waveguide 102. A tighter radius of curvature will permit smaller Mach-Zender Interferometers to be produced.

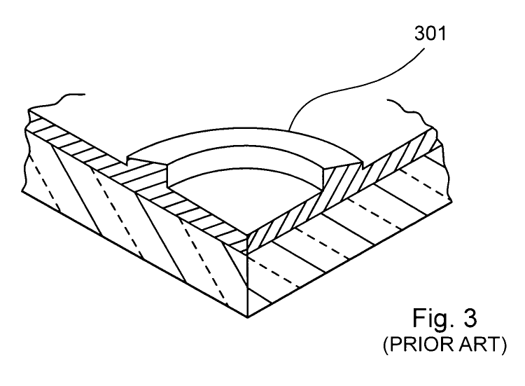

Referring to FIG. 2, a section view of the waveguide substrate is shown in FIG. 1 including a curved ridge 202 over a curved waveguide region 203 and a straight ridge 204 over a straight waveguiding region 205. A first optical intensity profile 210 is superimposed over the curved waveguide region 203 and a second intensity profile 211 is superimposed over the straight waveguide region 205. As can be seen, the intensity profile 211 of the optical signal propagating within the straight waveguide region 205 is symmetric about the center of the ridge waveguide. As can be seen, the first intensity profile 210 is not symmetric about the center of the ridge waveguide 203, while the second intensity profile 211 is symmetric about the straight waveguide region 205.

Although the prior art example demonstrates a ridge waveguide structure, a person of skill in the art of waveguide design will appreciate that light propagating within curved and straight buried waveguides is guided in an analogous manner.

Referring to FIG. 3, a prior art waveguide structure is shown. This waveguide structure is described in detail in U.S. Pat. No. 5,511,142 by Horie et al. (FIG. 26}. In order to provide better confinement of light propagating within a weakly guided curved ridge waveguide, the thickness of the ridge 301 is varied to increase in a region where more guiding is desired and decrease in a region where less guiding is desired. Additionally, Horie modifies the local index of refraction such that it is higher along the inside of the curve further improving the confinement of the optical signal propagating therethrough. The techniques associated with the forming of this structure are unconventional. Forming a ridge waveguide with differing heights along the ridge typically involves many separate etching steps or highly specialized equipment capable of extremely precise etching.

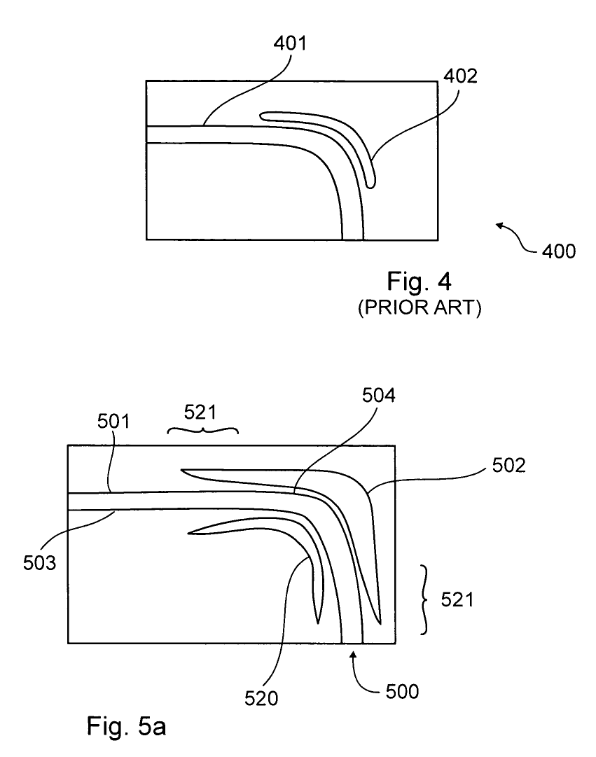

Referring to FIG. 4, a prior art waveguide structure is shown. The waveguide structure 400 includes: a ridge 401 with a radius of curvature, and a trench 402 with a radius of curvature. The trench 402 is positioned parallel to the ridge 401 such that the trench 402 will have a larger radius of curvature than the ridge 401. In this embodiment air is present in the trench 402, and therefore, the trench has a material therein having a very low index of refraction in comparison with the waveguide substrate. Thus, the confinement of the optical signal is significantly increased thereby causing an optical signal propagating along the waveguide to follow the curve of the ridge waveguide. This technique allows the minimum radius of curvature of the curved ridge waveguide to be much smaller than possible with the prior art as described with reference to FIG. 1 to FIG. 3.

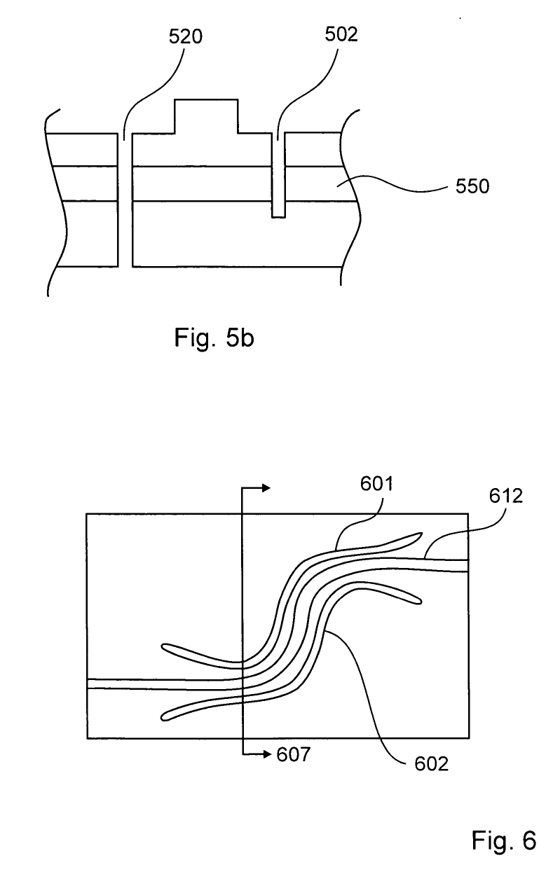

Referring to FIG. 5a, a first embodiment of the invention is shown. In this embodiment, a waveguide structure 500 includes a ridge waveguide 501 having a portion 503 without trenches and a portion 504 with trenches 502 and 520. A first trench 502 serves to enhance confinement of the optical signal within the waveguide portion 504. A second trench 520 is disposed on the inside curve of the waveguide portion 504. Referring to FIG. 5b a section view of the waveguide structure of FIG. 5a is shown. The section view clearly illustrates the depth of the trenches. The first trench 502 is illustrated as having a depth somewhat deeper than the base of a waveguide core layer 550. The second trench 520 is shown perforating the substrate. A person of skill in the art will be aware that once the depth of a trench has reached a certain point making the trench deeper will have a minimal effect on the waveguiding properties of the waveguide structure 500. Typically, it would be expected that a designer of skill in the art would ensure that the trench does not penetrate the entire depth of the waveguide structure 500 in order to maintain the structural strength of the waveguide structure 500. Referring again to FIG. 5a, in order to avoid a sharp transition between regions of the waveguide with trenches and without trenches, a transition region 521 is provided at both ends of the curved waveguide. Extending the trenches 502 and 520 beyond the curved region of the waveguide forms the transition region 521. As a person of skill in the art will be aware, the distance between the trenches and the ridge waveguide 501 will determine the effect that the trenches have on an optical signal propagating within the waveguide 501. When the trenches are disposed far from the waveguide 501 the effect of the trenches is minimal. Thus, in the transition region 521 the trenches are disposed far from the waveguide 501 however the trenches 502 and 520 both approach the waveguide slowly proximate the curved region of the waveguide. The transition region 521 is designed to permit relatively narrow confinement of the optical signal without a loss of energy of the optical signal. Thus, when the optical signal propagates from a region of the waveguide with trenches to a region of the waveguide without trenches energy in the optical signal remains in a lowest order singlemode. A person of skill in the art of waveguide design would describe this transition as adiabatic. Thus, in a first region of the waveguide structure, the waveguide structure is weakly confining to optical signals propagating therein. In a second region, the waveguide structure features a more robust confinement of optical signals propagating therein. The structure also supports a near adiabatic transition from the weakly confining region to the robust confinement region.

It is suggested that the shape of the curved part of the waveguide have a local radius of curvature that changes in a continuous manner. The geometry of the ridge of the waveguide when expressed as a function provides an infinite radius of curvature of the ridge waveguide at both ends of the bend where it joins with straight waveguide sections. Such a radius of curvature of the ridge waveguide is useful in minimizing an attenuation of an optical signal propagating within the curved ridge waveguide structure. Due to the presence of the trenches with a low index material therein, an optical signal propagating from a straight waveguide portion to the curved waveguide portion will experience a change in optical mode. When such a change occurs absent attenuation the change is said to be an adiabatic change. Thus, when properly designed, this embodiment of the invention provides a curved waveguide structure supporting near adiabatic changes in the optical mode. Since a very large index contrast exists between an air-filled trench and the waveguide material, a relatively sharp curvature of the waveguide is also supported. In contrast, the prior art waveguide bends consist of curves of the constant curvature connected to straight waveguide sections. In this case there is a mode mismatch at each interface between straight and circular sections or between two circular sections forming an S-bend waveguide. The optical mode passing through such a bend exhibits extra scattering losses and distortion of its profile. Using the waveguide structure of FIG. 5, the scattering losses and profile distortion are substantially reduced.

A person of skill in the art will appreciate that care should be taken in designing the waveguide structure. If the transition region 521 is too abrupt to permit the energy of the optical signal to remain in a lowest order single mode then energy will be transferred to unwanted higher order modes. This transfer of energy is not desirable and in many cases, energy transferred to the higher order mode will be lost. Additionally, if there is a set of weakly confined waveguides that are closely spaced then it is very important to minimize the excitation of higher order modes in order to minimize crosstalk.

Referring to FIG. 6, a second embodiment of the invention is shown featuring a curved, buried waveguide with trenches 601 and 602. This waveguide structure features an “S” bend with a trench disposed on either side of the waveguide core 612. The trenches 601 and 602 are positioned parallel to the waveguide core 612. Also shown in a section line 607.

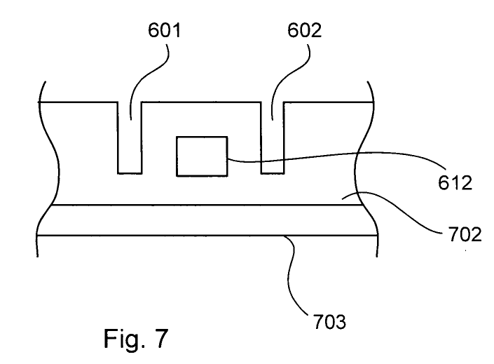

Referring to FIG. 7 a section view of a buried waveguide consistent with section line 607 of FIG. 6 is shown. The section view shows: a waveguide core 612, cladding 702, a substrate 703, and trenches 601 and 602. In order to enhance confinement of an optical signal propagating within the waveguide core 612, a low numerical index material is present within the trenches 601 and 602. Since the buried waveguide features a waveguide core 612 that is surrounded by cladding 702 the waveguide core 612 is often considered more strongly guiding than a conventional ridge waveguide structure as described with reference to FIG. 2. Clearly, a wide variety of parameters, such as the numerical index for the various materials and the geometry of the waveguide, are used to produce the desired waveguiding properties. Despite having relatively stronger guiding than a ridge waveguide structure, it is still often the case that the waveguide core 612 is curved and that the radius of curvature of the curve is quite limited. By disposing trenches proximate the curved region of the waveguide a higher index contrast is generated resulting in better confinement of an optical signal proximate the waveguide core 612.

Although a variety of methods are available to form the trench, it is suggested that the trench be formed in a deep etching process. Deep etching is well established and understood by those of skill in the art of waveguide substrate fabrication. Additionally, a deep etching process is often used to form other features in a waveguide substrate, such as turning mirrors and grating facettes. Clearly, other methods of forming trenches are equally applicable to the invention.

The features used to help confine light to a waveguide region of a waveguide substrate as described with reference to the previous embodiments are referred to as trenches. Clearly, the description of the feature is not nearly as important as the function of the feature and therefore other features providing similar functionality are also referred to as a trench for the purposes of this document. For example, the features described as trenches in various embodiments of the invention are optionally provided with sufficient depth that they perforate the entire device. Thus, a properly shaped hole is used in place of a trench. As a person of skill in the art will be aware, this is merely a choice of words and should not be viewed as limiting the invention accordingly.

Numerous other embodiments of the invention may be envisioned by a person of skill in the art of waveguide design without departing from the spirit or scope of the invention. For example, having reviewed the embodiments of the invention, it is within the capability of a person of skill in the art of computer programming and optical design to provide a computer program for designing curved waveguides.

What is claimed is:

1. A waveguide structure comprising:
a waveguide; comprising;
a curved waveguide portion that is curved having local radii of curvature, and
a first trench disposed on an inside of the curvature of the waveguide, said first trench having a low index of refraction material disposed therein, said first trench comprising;
a first portion of the first trench disposed sufficiently distant the waveguide to prevent a change in mode profile of an optical signal propagating therein,
a second trench portion of the first trench disposed sufficiently proximate said waveguide to substantially enhance confinement of an optical signal propagating within the curved waveguide portion, and
a third trench portion of the first trench disposed sufficiently distant the waveguide to prevent a change in mode profile of an optical signal propagating therein.

2. A waveguide structure according to claim 1, wherein the curved waveguide portion comprises:
a first waveguide portion, said first waveguide portion being straight;
a second waveguide portion that is curved having local radii of curvature and optically coupled between the first waveguide portion and the third waveguide portion; and,
a third waveguide portion, said third waveguide portion being straight, said third waveguide portion optically coupled to the second waveguide portion;

3. A waveguide structure according to claim 1, comprising:
a second trench disposed on a second other side of the waveguide, said second trench having a low index of refraction material disposed therein, the second trench comprising:
a first trench portion of the second trench disposed sufficiently distant the waveguide to prevent a change in mode profile of an optical signal propagating therein;
a second trench portion of the second trench disposed sufficiently proximate said waveguide to substantially enhance confinement of an optical signal propagating within the second waveguide portion; and,
a third trench portion of the second trench disposed sufficiently distant the waveguide to prevent a change in mode profile of an optical signal propagating therein.

4. A waveguide structure according to claim 3, comprising:
a second waveguide, the second waveguide disposed on said waveguide structure on a side of the second trench opposite the first waveguide.

5. A waveguide structure according to claim 4, wherein the second waveguide is disposed sufficiently proximate the second trench to substantially enhance confinement of an optical signal propagating within the second waveguide.

6. A waveguide structure according to claim 1, wherein the local radius of curvature of the curved waveguide portion when expressed as a function of a distance that light propagates within the first waveguide portion, the second waveguide portion and the third waveguide portion has an approximately continuous first order derivative.

7. A waveguide structure according to claim 1, wherein the local radius of curvature of the second waveguide portion when expressed as a function of a distance that light propagates within the second waveguide portion has a continuous second order derivative.

8. A waveguide structure according to claim 7, comprising a semiconductor waveguide substrate.

9. A waveguide structure according to claim 1, wherein the waveguide is a ridge waveguide.

10. A waveguide structure according to claim 1, wherein the waveguide is a buried waveguide.

11. A waveguide structure according to claim 1, wherein at least one trench portion perforates the surface of the structure.

12. A waveguide structure according to claim 1, wherein at least one trench portion does not perforate the surface of the structure.

13. A waveguide substrate according to the claim 1, wherein the material with a low index of refraction is air.

14. A method of propagating an optical signal within a waveguide comprising:
providing an optical signal at an input port;
propagating said optical signal within a weakly confining portion of the waveguide;
propagating said optical signal within a transition region of the waveguide, said transition region of the waveguide supporting a near adiabatic optical mode transition; and,
propagating said optical signal within a strongly confining region of the waveguide.

15. A method of propagating an optical signal according to claim 14, comprising:
propagating said optical signal within a second transition region of the waveguide, said second transition region of the waveguide supporting a near adiabatic optical mode transition; and,
propagating said optical signal within a second weakly confining portion of the waveguide.

16. A method of propagating an optical signal according to claim 14, wherein the transition region comprises:
a first portion of a first trench disposed sufficiently distant the waveguide to prevent a change in mode profile of an optical signal propagating therein;
a second trench portion of the first trench disposed sufficiently proximate said waveguide to substantially enhance confinement of an optical signal propagating within the waveguide.

17. A method of propagating an optical signal according to claim 16, comprising: providing a second waveguide proximate the first waveguide such that the second trench portion is optically disposed between the first and second waveguides wherein said first and second waveguides are disposed on a same waveguide structure.

18. A storage medium for storing instructions for, when executed, resulting in a design for a waveguide structure, the waveguide structure comprising:
a waveguide comprising;
a curved waveguide portion that is curved having local radii of curvature, and
a first trench disposed on an inside of the curvature of the waveguide, said first trench having a low index of refraction material disposed therein, said first trench comprising;
a first portion of the first trench disposed sufficiently distant the waveguide to prevent a change in mode profile of an optical signal propagating therein,
a second trench portion of the first trench disposed sufficiently proximate said waveguide to substantially enhance confinement of an optical signal propagating within the curved waveguide portion, and
a third trench portion of the first trench disposed sufficiently distant the waveguide to prevent a change in mode profile of an optical signal propagating therein.

19. A storage medium according to claim 18, wherein the design of the waveguide structure comprises:
a second waveguide disposed opposite the trench from the first waveguide.

20. A storage medium according to claim 19, wherein the second waveguide is disposed sufficiently proximate said second waveguide to substantially enhance confinement of an optical signal propagating within the second waveguide.
